(19) United States
(12) Patent Application Publication
(10) Pub. No.: US 2026/0119105 A1
(43) Pub. Date: Apr. 30, 2026

(54) VIDEO WALL AND VIDEO BOX CONTROLLER THEREOF

(71) Applicant: Novatek Microelectronics Corp., Hsinchu (TW)

(72) Inventors: Chun Tang Yang, Hsinchu City (TW); Jin-Ho Lin, Hsinchu County (TW); Nien-Tsung Hsueh, Hsinchu County (TW)

(73) Assignee: Novatek Microelectronics Corp., Hsinchu (TW)

(21) Appl. No.: 19/008,572

(22) Filed: Jan. 2, 2025

(30) Foreign Application Priority Data
May 9, 2024 (TW) 113117168

(51) Int. Cl. G06F 3/14; G06T 7/11

(52) U.S. Cl. CPC G06F 3/1446; G06T 7/11

(57) ABSTRACT

The disclosure provides a video wall and a video box controller thereof. The video wall includes multiple display daisy chains and a source image compressor. The source image compressor divides and compresses a source image into multiple compressed divided images. The display daisy chains are coupled to the source image compressor through different cables to receive different compressed divided images. Each of the display daisy chains includes multiple video boxes connected in series. Each of the video boxes includes a LED (light emitting diode) display module and a video box controller. The video box controller decompresses a received compressed divided image, and displays a corresponding divided image through the LED display module.

### CROSS-REFERENCE TO RELATED APPLICATION

This application claims the priority benefit of Taiwan application serial no. 113117168, filed on May 9, 2024. The entirety of the above-mentioned patent application is hereby incorporated by reference herein and made a part of this specification.

### BACKGROUND

### Technical Field

The disclosure relates to a display device, and more particularly, to a video wall and a video box controller thereof.

### Description of Related Art

Nowadays, a display screen of a video wall is formed by multiple video boxes. Each of the video boxes is controlled by one or more controllers. A source image device transmits a full-frame image data to one of the controllers. Each of the controllers receives full-frame image data and transmits the full-frame image data to the next controller. After a certain controller receives the full-frame image data, the controller will capture and process a corresponding partial image from the full-frame image data to display a processed corresponding partial image.

When a size of the video wall increases, that is, resolution of the image data increases, the number of controllers (video boxes) on the video wall will also increase. In addition, when the resolution of the image data increases, bandwidth requirements for image data transmission have also doubled. For example, an image of 8K is 4 times the amount of data of an image of 4K. How to transmit huge amounts of data between the source image device and the controllers has become one of the many technical issues in the field of the video wall.

### SUMMARY

The disclosure provides a video wall and a video box controller thereof, so that different portions of a source image may be efficiently transmitted to different video boxes.

In an embodiment of the disclosure, the video wall includes multiple display daisy chains and a source image compressor. The source image compressor is configured to divide and compress the source image into multiple compressed divided images. The display daisy chains are coupled to the source image compressor through different cables to receive different corresponding compressed divided images. Each of the display daisy chains includes multiple video boxes connected in series. Each of the video boxes includes a light emitting diode display module and a video box controller. The video box controller decompresses a received compressed divided image, and display a portion of a corresponding divided image through the light emitting diode display module.

In an embodiment of the disclosure, the video box controller is configured to control a video box. The video box controller includes an image divider and a decompressor. The image divider divides a partial compressed image from a compressed divided image. The decompressor is coupled to the image divider to receive the partial compressed image. The decompressor decompresses the partial compressed image to generate a first image, so that the first video box displays a portion of a corresponding divided image.

In an embodiment of the disclosure, the video wall includes a display daisy chain and a source image compressor. The source image compressor compresses a source image by using a tile-based compression algorithm to generate a compressed image. The display daisy chain is coupled to the source image compressor through a cable to receive the compressed image. The display daisy chain includes multiple video boxes connected in series. Each of the video boxes includes a light emitting diode display module and a video box controller. The video box controller of any one of the video boxes of the display daisy chain divides a partial compressed image from the compressed image. The video box controller of the any one of the video boxes of the display daisy chain decompresses the partial compressed image to display a portion of a corresponding divided image through the light emitting diode display module.

Based on the above, in an embodiment, different video boxes are grouped into the display daisy chains, while the source image compressor divides the source image into the divided images corresponding to the display daisy chains, and the source image compressor compresses any one of the divided images to the corresponding display daisy chain. Therefore, bandwidth requirements for image data transmission between the corresponding display daisy chain and the source image compressor may be effectively reduced, and bandwidth requirements for image data transmission between different video box controllers of the corresponding display daisy chain may also be effectively reduced. In another embodiment, the source image compressor compresses the source image by using the tile-based compression algorithm. Therefore, the video box controller directly divides the partial compressed image thereof from the compressed image. Since the video box controller first divides the compressed image and then decompresses the partial compressed image, resource costs of decompression of the video box controller may be effectively reduced. Therefore, different portions of the source image may be efficiently transmitted to different video boxes.

In order for the aforementioned features and advantages of the disclosure to be more comprehensible, embodiments accompanied with drawings are described in detail below.

### BRIEF DESCRIPTION OF THE DRAWINGS

FIG. 1 is a schematic circuit block diagram of a video wall according to an embodiment.

FIG. 2 is a schematic diagram of a displayed image of a video wall according to an embodiment.

FIG. 3 is a schematic circuit block diagram of a video wall according to an embodiment of the disclosure.

FIG. 4 is a schematic circuit block diagram of a source image compressor according to an embodiment of the disclosure.

FIG. 5 is a schematic circuit block diagram of a video box controller according to an embodiment of the disclosure.

FIG. 6 is a schematic circuit block diagram of a video box controller according to another embodiment of the disclosure.

FIG. 7 is a schematic circuit block diagram of a video wall according to another embodiment of the disclosure.

FIG. 8 is a schematic flowchart of an operating method of a video wall according to an embodiment of the disclosure.

FIG. 9 is a schematic flowchart of an operating method of a video wall according to another embodiment of the disclosure.

FIG. 10 is a schematic flowchart of an operating method of a video wall according to yet another embodiment of the disclosure.

### DETAILED DESCRIPTION OF DISCLOSED EMBODIMENTS

The term “coupling (or connection)” as used throughout the present specification (including the claims) may refer to any direct or indirect connection means. For example, if it is described that a first device is coupled (or connected) to a second device, it should be interpreted that the first device can be directly connected to the second device, or the first device can be indirectly connected to the second device through other devices or a certain connection means. The terms “first”, “second” and the like as mentioned throughout the present specification (including the claims) are used to name the elements or to distinguish between different embodiments or scopes, rather than setting an upper or lower limit on the number of the elements or the order of the elements. In addition, wherever possible, elements/components/steps with the same reference numerals in the drawings and embodiments represent the same or similar parts. Cross-reference may be made between the elements/components/steps in different embodiments that are denoted by the same reference numerals or that have the same names.

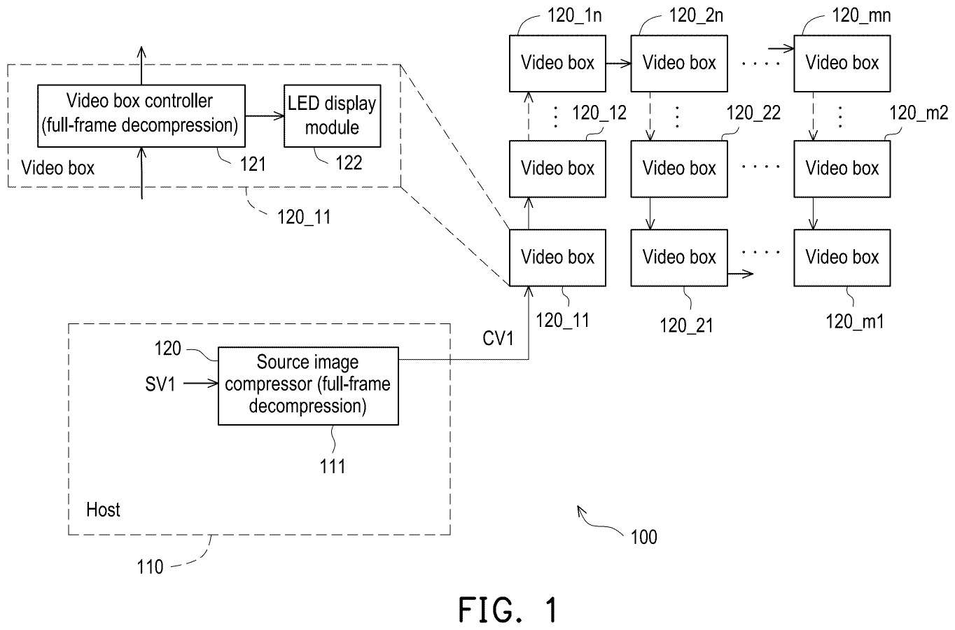

FIG. 1 is a schematic circuit block diagram of a video wall 100 according to an embodiment. The video wall 100 includes a host 110 and multiple video boxes 120_11, 120_12, . . . , 120_1n, 120_21, 120_22, . . . , 120_2n, . . . , 120_m1, 120_m2, . . . , 120_mn. The video boxes 120_11 to 120_mn may be set up as a box array, in which the number of columns n and the number of rows m may be determined according to an actual design. In order to increase a transmission bandwidth, an image compression algorithm is introduced into a system. By using a non-tile based compression algorithm, a source image compressor 111 of the host 110 performs full-frame compression on a source image SV1 to generate a compressed image CV1. The source image compressor 111 transmits the compressed image CV1 to video box controllers of the video boxes 120_11 to 120_mn through a high-speed transmission interface. Therefore, bandwidth requirements for image data transmission between the source image compressor 111 and the video boxes 120_11 to 120_mn may be effectively reduced.

The video boxes 120_11 to 120_mn have substantially the same circuit structure. For example, the video box 120_11 includes a video box controller 121 and a light emitting diode (LED) display module 122. The video box controller 121 of the video box 120_11 receives the compressed image CV1 from the source image compressor 111, and then transmits the compressed image CV1 to the next video box 120_12. In addition, the video box controller 121 of the video box 120_11 performs full-frame decompression on the compressed image CV1 to generate a decompressed full-frame image (in which the compressed image CV1 is restored to the source image SV1). The video box controller 121 of the video box 120_11 captures a partial image thereof from the decompressed full-frame image to the LED display module 122, while other portions of the decompressed full-frame image are discarded. Based on a decompressed corresponding partial image provided by the video box controller 121, the LED display module 122 may display a corresponding portion of a displayed image of the video wall 100. Relevant descriptions of the video box 120_11 may be referred for other video boxes, and the rest may be derived by analogy. Therefore, the same details will not be repeated in the following.

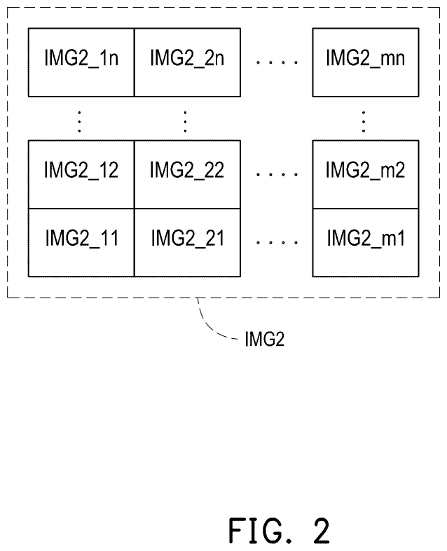

FIG. 2 is a schematic diagram of a displayed image IMG2 of the video wall 100 according to an embodiment. Referring to FIGS. 1 and 2, the displayed image IMG2 of the video wall 100 may be divided into partial images IMG2_11, IMG2_12, . . . , IMG2_1n, IMG2_21, IMG2_22, . . . , IMG2_2n, . . . , IMG2_m1, IMG2_m2, . . . , IMG2_mn. The partial images IMG2_11 to IMG2_mn correspond to the video boxes 120_11 to 120_mn respectively. The video box controller 121 of the video box 120_11 performs the full-frame decompression on the compressed image CV1 to generate the image IMG2 (the decompressed full-frame image). The video box controller 121 of the video box 120_11 captures the partial image IMG2_11 thereof from the image IMG2 to the LED display module 122. Based on the decompressed corresponding partial image provided by the video box controller 121, the LED display module 122 of the video box 120_11 may display the corresponding partial image IMG2_11 of the displayed image IMG2 of the video wall 100. Except for the partial image IMG2_11, the video box controller 121 of the video box 120_11 discards other partial images of the image IMG2. However, for the discarded partial images, a decompression operation is wasteful.

In the following embodiments, it will be described that through a design of a combination of a front-end compressor and a back-end decompressor with a daisy chain topology, decompression workload of each of the video box controllers may be effectively reduced, reducing a waste of the transmission bandwidth, as well as reducing energy consumption of unnecessary data transmission and costs of the overall system.

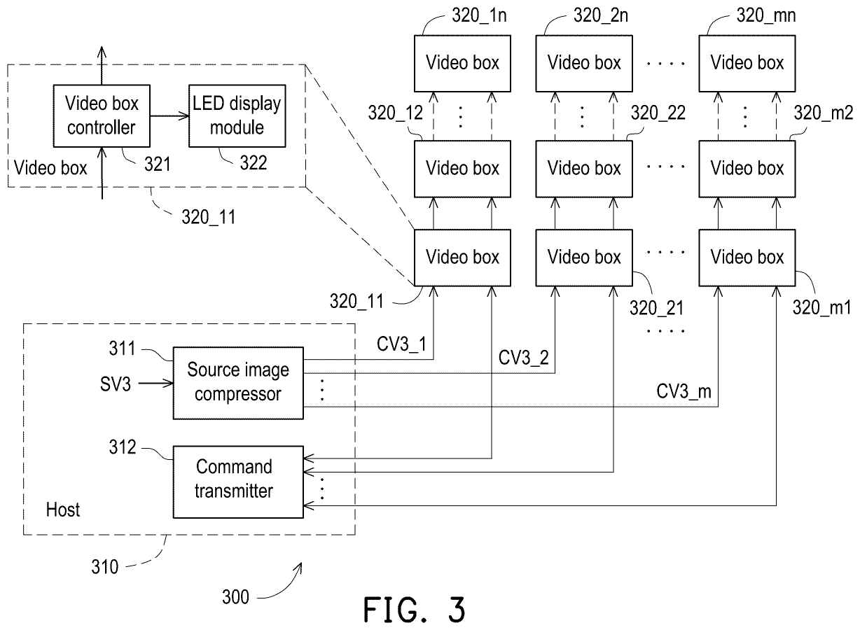

FIG. 3 is a schematic circuit block diagram of a video wall 300 according to an embodiment of the disclosure. The video wall 300 includes multiple display daisy chains and a host 310. Each of the display daisy chains includes multiple video boxes connected in series. For example, the first display daisy chain includes video boxes 320_11, 320_12, . . . , 320_1n connected in series, and the second display daisy chain includes video boxes 320_21, 320_22, . . . , 320_2n connected in series. By analogy, the m-th display daisy chain includes video boxes 320_m1, 320_m2, . . . , 320_mn connected in series. Referring to FIGS. 2 and 3, the video boxes 320_11 to 320_mn of the display daisy chains respectively display different partial images IMG2_11 to IMG2_mn of the displayed image IMG2 of the video wall 300.

The host 310 includes the source image compressor 311 and a command transmitter 312. The command transmitter 312 transmits various commands to the video boxes 320_11 to 320_mn. For example, the commands may include “read commands” (used to read a state of the video box controller), “setting commands” (used to set/write control parameters to the video box controller), or other commands. The control parameters may include decompression parameters (e.g., “decompression range” parameters and “compression rate” parameters), display parameters, or other control parameters.

The source image compressor 311 is coupled to different display daisy chains through different cables. The source image compressor 311 divides a source image SV3 into multiple divided images respectively corresponding to different display daisy chains, and then compresses the divided images into compressed divided images CV3_1, CV3_2, . . . , CV3_m. For example, the first divided image including the partial images IMG2_11 to IMG2_1n corresponds to the first display daisy chain (the video boxes 320_11 to 320_1n), and the second divided image including the partial images IMG2_21 to IMG2_2n corresponds to the second display daisy chain (the video boxes 320_21 to 320_2n). By analogy, the m-th divided image including the partial images IMG2_m1 to IMG2_mn corresponds to the m-th display daisy chain (the video boxes 320_m1 to 320_mn).

The source image compressor 311 compresses any one of the divided images to generate a corresponding compressed divided image of the compressed divided images to a corresponding display daisy chain of the display daisy chains. For example, the source image compressor 311 compresses the first divided image (the partial images IMG2_11 to IMG2_1n) to generate the compressed divided image CV3_1 to the first display daisy chain (the video boxes 320_11 to 320_1n). By analogy, the source image compressor 311 generates the compressed divided image CV3_2 to CV3_m to other display daisy chains.

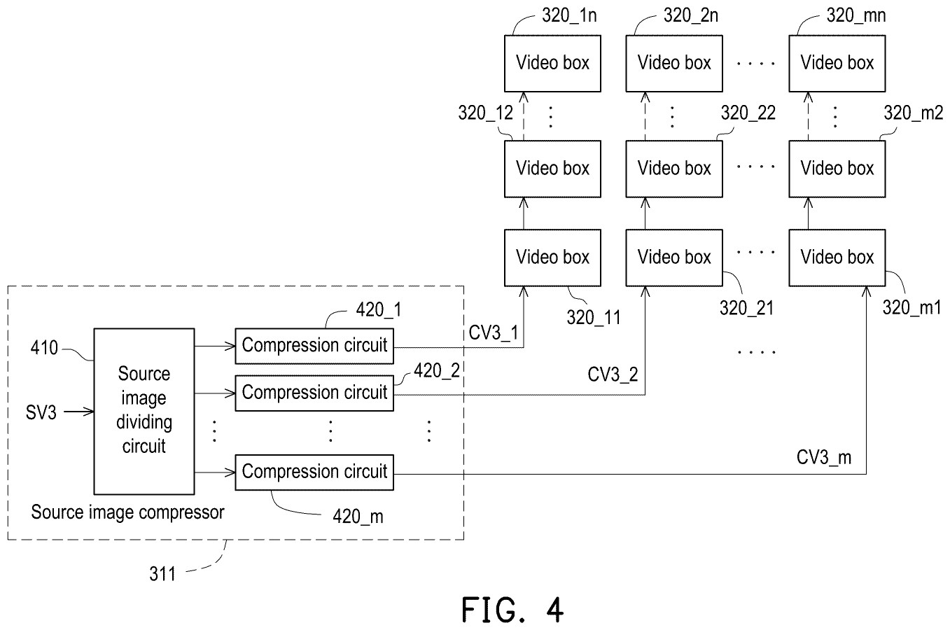

FIG. 4 is a schematic circuit block diagram of the source image compressor 311 according to an embodiment of the disclosure. The source image compressor 311 shown in FIG. 4 may be used as one of many embodiments of the source image compressor 311 shown in FIG. 3. In the embodiment shown in FIG. 4, the source image compressor 311 includes a source image dividing circuit 410 and multiple compression circuits 420_1, 420_2, . . . ,420_m. The source image dividing circuit 410 divides the source image SV3 into the divided images. The compression circuits 420_1 to 420_m are coupled to the source image dividing circuit 410 to receive corresponding divided images respectively. Any one of the compression circuits compresses the corresponding divided image to generate the corresponding compressed divided image to the corresponding display daisy chain. For example, the compression circuit 420_1 compresses the first divided image (the partial images IMG2_11 to IMG2_1n), and generates the compressed divided image CV3_1 to the first display daisy chain (the video boxes 320_11 to 320_1n). By analogy, the compression circuits 420_2 to 420_m generate the compressed divided images CV3_2 to CV3_m to other display daisy chains.

The corresponding display daisy chain decompresses a corresponding compressed image to display a corresponding portion of the displayed image IMG2. Referring to FIG. 3, the video boxes 320_11 to 320_mn have substantially the same circuit structure. Each of the video boxes includes a LED display module and a video box controller. For example, the video box 320_11 includes a video box controller 321 and a LED display module 322. The video box controller 321 of the video box 320_11 receives the compressed divided image CV3_1 from the source image compressor 311, and then transmits the compressed divided image CV3_1 to the next video box 320_12. Relevant descriptions of the video box 320_11 may be referred for other video boxes, and the rest may be derived by analogy. Therefore, the same details will not be repeated in the following.

Based on the above, different video boxes are grouped into the display daisy chains, while the source image compressor 311 divides the source image SV3 into the divided images corresponding to the display daisy chains, and the source image compressor 311 compresses any one of the divided images to generate the corresponding compressed divided image to the corresponding display daisy chain. Therefore, bandwidth requirements for image data transmission between the corresponding display daisy chain and the source image compressor 311 may be effectively reduced, and bandwidth requirements for image data transmission between different video box controllers of the corresponding display daisy chain may also be effectively reduced. Therefore, different portions of the source image SV3 may be efficiently transmitted to different video boxes 320_11 to 320_mn.

Referring to FIG. 3, the video box 320_11 is used as an example for description here, and the relevant descriptions of the video box 320_11 may be referred for other video boxes, and the rest may be derived by analogy. In some embodiments, the video box controller 321 of the video box 320_11 may first perform decompression and then perform image dividing. The source image compressor 311 outputs the compressed divided image CV3_1 to the video box controller 321 of the first video box 320_11 of the corresponding display daisy chain (the video boxes 320_11 to 320_1n) through the corresponding cable. The video box controller 321 of the video box 320_11 decompresses the compressed divided image CV3_1 to generate the divided image (e.g., the partial images IMG2_11 to IMG2_1n shown in FIG. 2). The video box controller 321 of the video box 320_11 divides a first image (a partial image corresponding to the video box 320_11, such as the partial image IMG2_11 shown in FIG. 2) from the divided image. The video box controller 321 of the video box 320_11 controls the LED display module 322 of the video box 320_11 to display the first image. In addition, the video box controller 321 of the video box 320_11 transmits the compressed divided image CV3_1 to the video box controller of the second video box 320_12 belonging to the same display daisy chain.

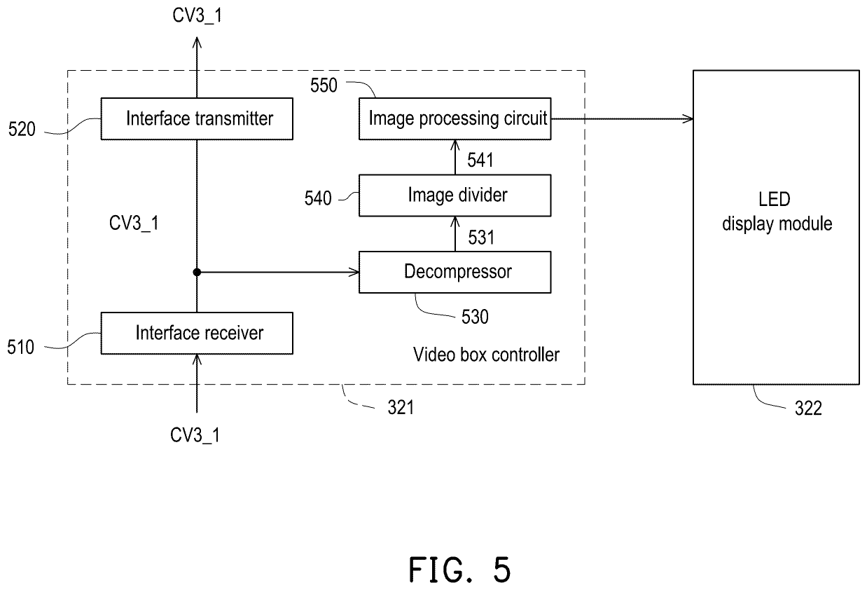

FIG. 5 is a schematic circuit block diagram of the video box controller 321 according to an embodiment of the disclosure. The video box controller 321 shown in FIG. 5 may be used as one of many embodiments of the video box controller 321 shown in FIG. 3. In the embodiment shown in FIG. 5, the video box controller 321 includes an interface receiver 510, an interface transmitter 520, a decompressor 530, an image divider 540, and an image processing circuit 550. Referring to FIGS. 3 and 5, the interface receiver 510 receives the compressed divided image CV3_1 from the source image compressor 311. The interface transmitter 520 is coupled to the interface receiver 510 to receive the compressed divided image CV3_1. The interface transmitter 520 transmits the compressed divided image CV3_1 to the video box controller of the second video box 320_12 belonging to the same display daisy chain.

The decompressor 530 is coupled to the interface receiver 510 to receive the compressed divided image CV3_1. The decompressor 530 decompresses the compressed divided image CV3_1 to generate a divided image 531 (e.g., the partial images IMG2_11 to IMG2_1n shown in FIG. 2). The image divider 540 is coupled to the decompressor 530 to receive the divided image 531. The image divider 540 divides a first image 541 (a partial image corresponding to the video box 320_11, such as the partial image IMG2_11 shown in FIG. 2) from the divided image 531, so that the LED display module 322 of the video box 320_11 displays the first image 541. The image processing circuit 550 is coupled to the image divider 540 to receive the first image 541. The image processing circuit 550 performs image processing on the first image 541, so that the LED display module 322 of the video box 320_11 displays the first image 541 (e.g., the partial image IMG2_11 shown in FIG. 2).

In other embodiments, referring to FIG. 3, the video box controllers of the video boxes 320_11 to 320_mn may first perform the image dividing and then perform the decompression. The source image compressor 311 may compress different divided images respectively to generate the compressed divided images CV3_1 to CV3_m by using a “tile-based compression algorithm”. The “tile-based compression algorithm” may be any technology that performs image compression with a tile as a unit. Each of the different partial images IMG2_11 to IMG2_mn corresponding to the video boxes 320_11 to 320_mn includes one or more tiles. Since a unit of compression for the compression algorithm used by the source image compressor 311 is “tile”, the video box controller may directly divide a partial compressed image from the compressed divided image without decompression.

Here, the video box 320_11 is still used as the example for description, while the relevant descriptions of the video box 320_11 may be referred for other video boxes, and the rest may be derived by analogy. The source image compressor 311 outputs the compressed divided image CV3_1 to the video box controller 321 of the first video box 320_11 of the corresponding display daisy chain (the video boxes 320_11 to 320_1n) through the corresponding cable. The video box controller 321 of the video box 320_11 divides the partial compressed image corresponding to the video box 320_11 from the compressed divided image CV3_1. The video box controller 321 of the video box 320_11 decompresses the partial compressed image to generate the first image (corresponding to a portion of the divided image, such as the partial image IMG2_11 shown in FIG. 2). The video box controller 321 of the video box 320_11 controls the video box 320_11 to display the partial image IMG2_11 shown in FIG. 2. In addition, the video box controller 321 of the video box 320_11 further transmits the compressed divided image CV3_1 to the video box controller of the second video box 320_12 belonging to the same display daisy chain.

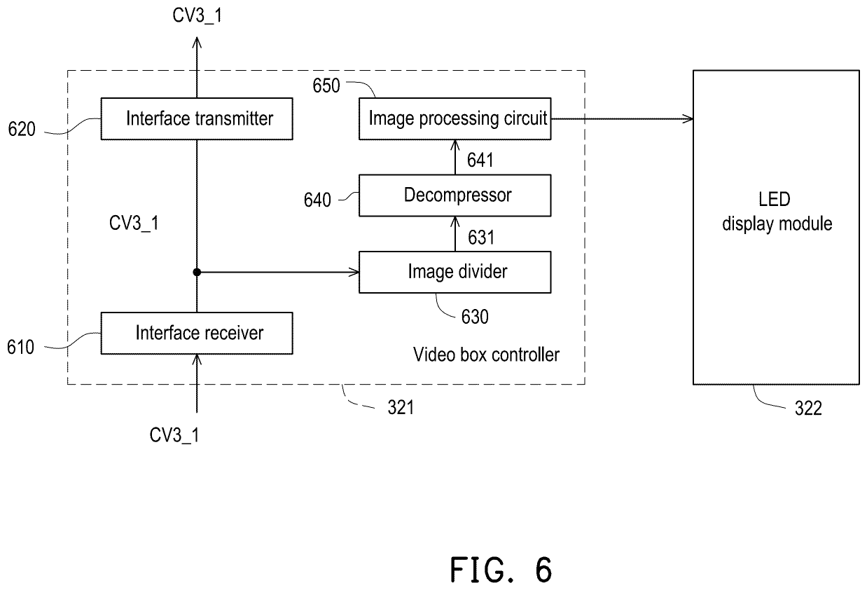

FIG. 6 is a schematic circuit block diagram of the video box controller 321 according to another embodiment of the disclosure. The video box controller 321 shown in FIG. 6 may be used as one of many embodiments of the video box controller 321 shown in FIG. 3. In the embodiment shown in FIG. 6, the video box controller 321 includes an interface receiver 610, an interface transmitter 620, an image divider 630, a decompressor 640, and an image processing circuit 650. Referring to FIGS. 3 and 6, the interface receiver 610 receives the compressed divided image CV3_1 from the source image compressor 311. The interface transmitter 620 is coupled to the interface receiver 610 to receive the compressed divided image CV3_1. The interface transmitter 620 transmits the compressed divided image CV3_1 to the video box controller of the second video box 320_12 belonging to the same display daisy chain.

The image divider 630 is coupled to the interface receiver 610 to receive the compressed divided image CV3_1. The image divider 630 divides a partial compressed image 631 corresponding to the video box 320_11 from the compressed divided image CV3_1. The decompressor 640 is coupled to the image divider 630 to receive the partial compressed image 631. The decompressor 640 decompresses the partial compressed image 631 to generate a first image 641 (corresponding to the portion of the divided image, such as the partial image IMG2_11 shown in FIG. 2), so that the video box 320_11 displays the first image 641. The image processing circuit 650 is coupled to the decompressor 640 to receive the first image 641. The image processing circuit 650 performs the image processing on the first image 641, so that the LED display module 322 of the video box 320_11 displays the first image 641 (corresponding to the portion of the divided image, such as the partial image IMG2_11 shown in FIG. 2).

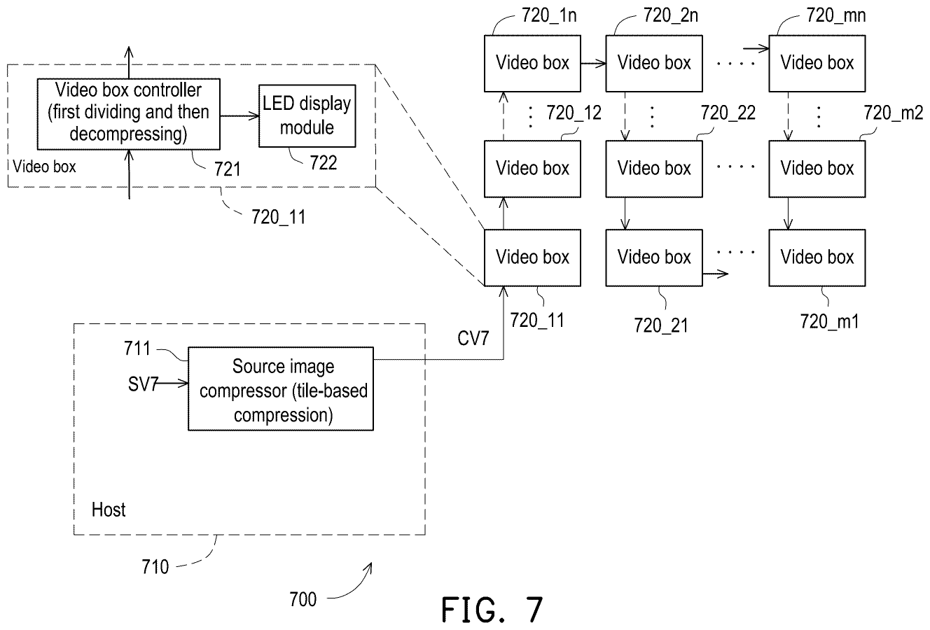

FIG. 7 is a schematic circuit block diagram of a video wall 700 according to another embodiment of the disclosure. The video wall 700 includes a single display daisy chain and a host 710. The display daisy chain shown in FIG. 7 includes video boxes 720_11, 720_12, . . . , 720_1n, 720_2n, . . . , 720_22, 720_21, . . . , 720_mn, . . . , 720_m2, 720_m1 connected in series. Referring to FIGS. 2 and 7, the video boxes 720_11 to 720_mn of the display daisy chain respectively display the different partial images IMG2_11 to IMG2_mn of the displayed image IMG2 of the video wall 700.

Relevant descriptions of the host 310 shown in FIG. 3 may be referred for the host 710 shown in FIG. 7, and the rest may be derived by analogy. The host 710 shown in FIG. 7 includes the source image compressor 711. The source image compressor 711 is coupled to the first video box of the display daisy chain through the cable. The source image compressor 711 compresses a source image SV7 to generate a compressed image CV7 to the display daisy chain by using the tile-based compression algorithm.

The video boxes 720_11 to 720_mn have substantially the same circuit structure. Each of the video boxes includes the LED display module and the video box controller. For example, the video box 720_11 includes a video box controller 721 and a LED display module 722. The video box controller 721 of the video box 720_11 receives the compressed image CV7 from the source image compressor 711, and then transmits the compressed image CV7 to the next video box 720_12. Relevant descriptions of the video box 720_11 may be referred for other video boxes, and the rest may be derived by analogy. Therefore, the same details will not be repeated in the following.

Since the unit of compression for the compression algorithm used by the source image compressor 311 is “tile”, the video box controllers of the video boxes 720_11 to 720_mn may first directly divide a partial compressed image from the compressed image CV7 without decompression, and then decompress the respective partial compressed images. Here, the video box 720_11 is still used as the example for description, while the relevant descriptions of the video box 720_11 may be referred for other video boxes, and the rest may be derived by analogy. The source image compressor 711 outputs the compressed image CV7 to the video box controller 721 of the first video box 720_11 of the display daisy chain through the cable. The video box controller 721 of the video box 720_11 directly divides the partial compressed image corresponding to the video box 720_11 from the compressed image CV7. The video box controller 721 of the video box 720_11 decompresses the partial compressed image to generate the first image (e.g., the partial image IMG2_11 shown in FIG. 2). The video box controller 721 of the video box 720_11 controls the LED display module 722 of the video box 720_11 to display the first image. In addition, the video box controller 721 of the video box 720_11 transmits the compressed image CV7 to the video box controller of the next video box 720_12.

The video box controller 321 shown in FIG. 6 may be used as one of many embodiments of the video box controller 721 shown in FIG. 7. In other embodiments, the video box controller 721 may be implemented in other ways than the video box controller 321 shown in FIG. 6.

Based on the above, the source image compressor 711 compresses the source image SV7 by using the tile-based compression algorithm. Therefore, the video box controller (e.g., the video box controller 721 of the video box 720_11) may directly divide the partial compressed image thereof from the compressed image CV7. Since the video box controller 721 first divides the compressed image and then decompresses the partial compressed image, resource costs of decompression of the video box controller 721 may be effectively reduced.

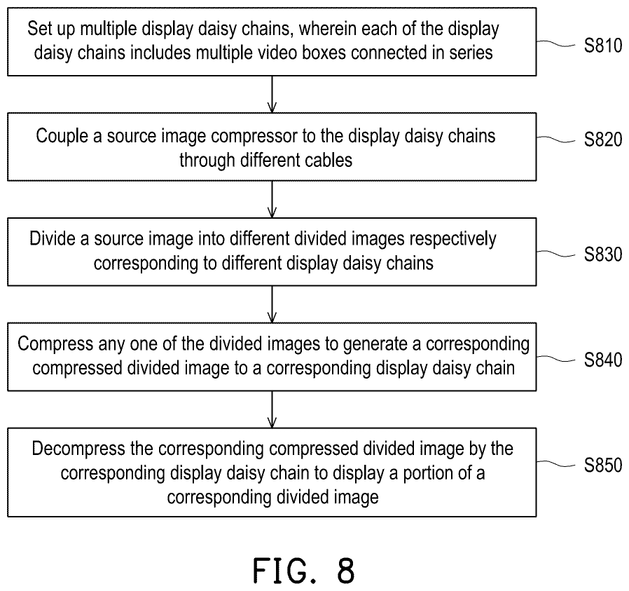

FIG. 8 is a schematic flowchart of an operating method of a video wall according to an embodiment of the disclosure. In step S810, multiple display daisy chains are set up. Each of the display daisy chains includes multiple video boxes connected in series. Each of the video boxes includes a LED display module and a video box controller, and the different video boxes of the display daisy chains display different portions of a displayed image of the video wall. In step S820, a source image compressor is coupled to the different display daisy chains through different cables. In step S830, the source image compressor divides a source image into multiple divided images respectively corresponding to the different display daisy chains. In step S840, the source image compressor compresses any one of the divided images to generate a corresponding compressed divided image of multiple compressed divided images to a corresponding display daisy chain of the display daisy chains. In step S850, the corresponding display daisy chain decompresses the corresponding compressed divided image to display a portion of a corresponding divided image.

In some embodiments, the operating method further includes the following. The source image is divided into the divided images by a source image dividing circuit of the source image compressor. The corresponding divided image of the divided images is compressed by any one of multiple compressed circuits of the source image compressor to generate the corresponding compressed divided image of the compressed divided images to the corresponding display daisy chain of the display daisy chains.

In some embodiments, the operating method further includes the following. The corresponding compressed divided image is output to the video box controller of the first video box of the video boxes of the corresponding display daisy chain by the source image compressor through a corresponding cable of the different cables. The corresponding compressed divided image is decompressed by the video box controller of the first video box of the corresponding display daisy chain to generate the corresponding divided image. A first image corresponding to the first video box of the corresponding display daisy chain is divided from the corresponding divided image by the video box controller of the first video box of the corresponding display daisy chain. The first video box of the corresponding display daisy chain is controlled to display the first image by the video box controller of the first video box of the corresponding display daisy chain. The corresponding compressed divided image is transmitted to the video box controller of the second video box of the video boxes of the corresponding display daisy chain by the video box controller of the first video box of the corresponding display daisy chain.

In some embodiments, the operating method further includes the following. The corresponding compressed divided image is decompressed by a decompressor of the video box controller of the first video box of the corresponding display daisy chain to generate the corresponding divided image. An image divider is coupled to the decompressor to receive the corresponding divided image. The first image corresponding to the first video box of the corresponding display daisy chain is divided from the corresponding divided image by the image divider, so that the first video box of the corresponding display daisy chain displays the first image.

In some embodiments, the operating method further includes the following. The corresponding compressed divided image is received from the source image compressor by an interface receiver of the video box controller of the first video box of the display daisy chain. The decompressor is coupled to the interface receiver to receive the corresponding compressed divided image. An interface transmitter of the video box controller of the first video box of the corresponding display daisy chain is coupled to the interface receiver to receive the corresponding compressed divided image. The corresponding compressed divided image is transmitted to the video box controller of the second video box of the corresponding display daisy chain by the interface transmitter.

In some embodiments, the operating method further includes the following. The image processing is performed on the first image by an image processing circuit of the video box controller of the first video box of the corresponding display daisy chain, so that the light emitting diode display module of the first video box of the corresponding display daisy chain displays the first image. The image processing circuit is coupled to the image divider to receive the first image.

In some embodiments, the operating method further includes the following. The divided images are respectively compressed by using the tile-based compression algorithm by the source image compressor to generate the compressed divided images. The corresponding compressed divided image is output to the video box controller of the first video box of the video boxes of the corresponding display daisy chain by the source image compressor through the corresponding cable of the different cables. A partial compressed image corresponding to the first video box of the corresponding display daisy chain is divided from the corresponding compressed divided image by the video box controller of the first video box of the corresponding display daisy chain. The partial compressed image is decompressed by the video box controller of the first video box of the corresponding display daisy chain to generate the first image. The first video box of the corresponding display daisy chain is controlled to display the first image (a portion of the corresponding divided image) by the video box controller of the first video box of the corresponding display daisy chain. The corresponding compressed divided image is transmitted to the video box controller of the second video box of the video boxes of the corresponding display daisy chain by the video box controller of the first video box of the corresponding display daisy chain.

In some embodiments, the operating method further includes the following. The partial compressed image corresponding to the first video box of the corresponding display daisy chain is divided from the corresponding compressed divided image by the image divider of the video box controller of the first video box of the corresponding display daisy chain. The partial compressed image is decompressed by the decompressor of the video box controller of the first video box of the corresponding display daisy chain to generate the first image, so that the first video box of the corresponding display daisy chain displays the portion of the corresponding divided image. The decompressor is coupled to the image divider to receive the partial compressed image.

In some embodiments, the operating method further includes the following. The corresponding compressed divided image from the source image compressor is received by the interface receiver of the video box controller of the first video box of the corresponding display daisy chain. The image divider is coupled to the interface receiver to receive the corresponding compressed divided image. The corresponding compressed divided image is transmitted to the video box controller of the second video box of the corresponding display daisy chain by the interface transmitter of the video box controller of the first video box of the corresponding display daisy chain. The interface transmitter is coupled to the interface receiver to receive the corresponding compressed divided image.

In some embodiments, the operating method further includes the following. The image processing is performed on the first image by the image processing circuit of the video box controller of the first video box of the corresponding display daisy chain, so that the light emitting diode display module of the first video box of the corresponding display daisy chain displays the first image. The image processing circuit is coupled to the decompressor to receive the first image.

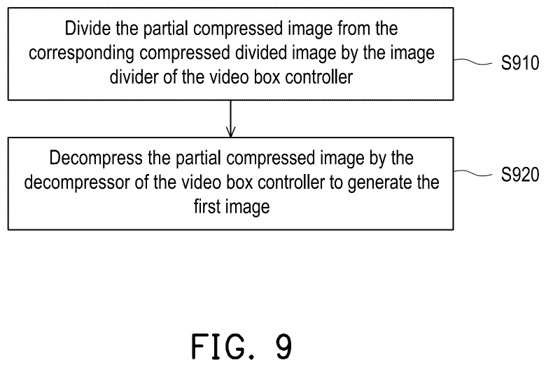

FIG. 9 is a schematic flowchart of an operating method of a video wall according to another embodiment of the disclosure. In step S910, the image divider of the video box controller divides the partial compressed image from the corresponding compressed divided image. In step S920, the decompressor of the video box controller decompresses the partial compressed image to generate the first image, so that the first video box displays the first image. The decompressor is coupled to the image divider to receive the partial compressed image.

In some embodiments, the operating method further includes the following. The corresponding compressed divided image from the source image compressor is received by the interface receiver of the video box controller. The image divider is coupled to the interface receiver to receive the corresponding compressed divided image. The corresponding compressed divided image is transmitted to another video box controller of the second video box by the interface transmitter of the video box controller. The interface transmitter is coupled to the interface receiver to receive the corresponding compressed divided image.

In some embodiments, the first video box further includes the light emitting diode display module, and the operating method further includes the following. The image processing is performed on the first image by the image processing circuit of the video box controller, so that the light emitting diode display module of the first video box displays the first image. The image processing circuit is coupled to the decompressor to receive the first image.

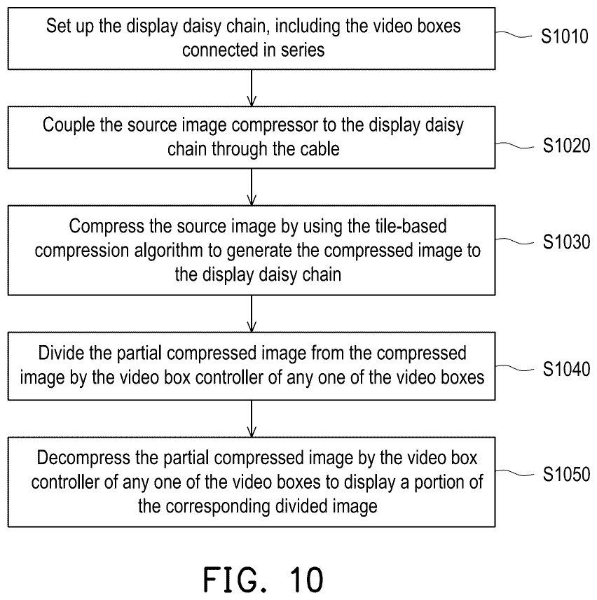

FIG. 10 is a schematic flowchart of an operating method of a video wall according to yet another embodiment of the disclosure. In step S1010, the display daisy chain is set up. The display daisy chain includes the video boxes connected in series. Each of the video boxes includes the LED display module and the video box controller, and the video boxes display different portions of the displayed image of the video wall. In step S1020, the source image compressor is coupled to the display daisy chain through the cable. In step S1030, the source image compressor compresses the source image by using the tile-based compression algorithm to generate the compressed image to the display daisy chain. In step S1040, the video box controller of any one of the video boxes divides the partial compressed image from the compressed image. In step S1050, the video box controller of any one of the video boxes decompresses the partial compressed image to display the portion of the corresponding divided image through the LED display module.

In some embodiments, the operating method further includes the following. The compressed image is output to the video box controller of the first video box of the video boxes of the corresponding display daisy chain by the source image compressor through the corresponding cable. The partial compressed image corresponding to the first video box is divided from the compressed image by the video box controller of the first video box. The partial compressed image is decompressed by the video box controller of the first video box to generate the first image. The first video box is controlled to display the first image by the video box controller of the first video box. The compressed image is transmitted to the video box controller of the second video box of the video boxes of the corresponding display daisy chain by the video box controller of the first video box.

In some embodiments, the operating method further includes the following. The partial compressed image corresponding to the first video box is divided from the compressed image by the image divider of the video box controller of the first video box. The partial compressed image is decompressed by the decompressor of the video box controller of the first video box to generate the first image, so that the first video box displays the first image. The decompressor is coupled to the image divider to receive the partial compressed image.

In some embodiments, the operating method further includes the following. The compressed image from the source image compressor is received by the interface receiver of the video box controller of the first video box. The image divider is coupled to the interface receiver to receive the compressed image. The compressed image is transmitted to the video box controller of the second video box by the interface transmitter of the video box controller of the first video box. The interface transmitter is coupled to the interface receiver to receive the compressed image.

In some embodiments, the operating method further includes the following. The image processing is performed on the first image by the image processing circuit of the video box controller of the first video box, so that the light emitting diode display module of the first video box displays the first image. The image processing circuit is coupled to the decompressor to receive the first image.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A video wall, comprising:
a source image compressor configured to divide and compress a source image into a plurality of compressed divided images; and
a plurality of display daisy chains coupled to the source image compressor through different cables to receive different corresponding compressed divided images, wherein each of the display daisy chains comprises a plurality of video boxes connected in series, each of the video boxes comprises a light emitting diode display module and a video box controller, and the video box controller decompresses a received compressed divided image, and display a portion of a corresponding divided image through the light emitting diode display module.

2. The video wall according to claim 1, wherein the source image compressor comprises:
a source image dividing circuit configured to divide the source image into a plurality of divided images; and
a plurality of compression circuits coupled to the source image dividing circuit, wherein any one of the compression circuits compresses a corresponding divided image of the divided images to generate a corresponding compressed divided image to a corresponding display daisy chain of the display daisy chains.

3. The video wall according to claim 1, wherein a first display daisy chain of the display daisy chains comprises a first video box and a second video box, the video box controller of the first video box receives a corresponding compressed divided image through a corresponding cable and obtains a first image from the corresponding compressed divided image, and transmits the corresponding compressed divided image to the video box controller of the second video box, so that the second video box obtains a second image from the corresponding compressed divided image, wherein the first image is displayed by the light emitting diode display module of the first video box, and the second image is displayed by the light emitting diode display module of the second video box.

4. The video wall according to claim 3, wherein the video box controller of the first video box of the corresponding display daisy chain comprises:
a decompressor receiving and decompressing the corresponding compressed divided image to generate the corresponding divided image; and
an image divider coupled to the decompressor to receive the corresponding divided image, wherein the image divider divides the first image from the divided image, so that the light emitting diode display module of the first video box displays the first image.

5. The video wall according to claim 4, wherein the video box controller of the first video box of the corresponding display daisy chain further comprises:
an interface receiver receiving the corresponding compressed divided image; and
an interface transmitter coupled to the interface receiver, wherein the interface transmitter transmits the corresponding compressed divided image to the video box controller of the second video box.

6. The video wall according to claim 4, wherein the video box controller of the first video box of the corresponding display daisy chain further comprises:
an image processing circuit receiving the first image and enabling the light emitting diode display module of the first video box to display the first image.

7. The video wall according to claim 1, wherein the source image compressor divides the source image into a plurality of divided images, the source image compressor respectively compresses the divided images by using a tile-based compression algorithm to generate the compressed divided images, the source image compressor outputs a corresponding compressed divided image of the compressed divided images to the video box controller of a first video box of the video boxes of a corresponding display daisy chain of the corresponding display daisy chains, the video box controller of the first video box divides a partial compressed image of the first video box of the corresponding display daisy chain from the corresponding compressed divided image, and then decompresses the partial compressed image, so that the first video box displays a portion of a corresponding divided image, and the video box controller of the first video box further transmits the compressed divided image to a second video box of the corresponding display daisy chain.

8. The video wall according to claim 7, wherein the video box controller of the first video box of the corresponding display daisy chain comprises:
an image divider dividing the partial compressed image corresponding to the first video box of the corresponding display daisy chain from the corresponding compressed divided image; and
a decompressor coupled to the image divider to receive the partial compressed image, wherein the decompressor decompresses the partial compressed image to generate a first image, so that the first video box of the corresponding display daisy chain displays a portion of the corresponding divided image.

9. The video wall according to claim 8, wherein the video box controller of the first video box of the corresponding display daisy chain further comprises:
an interface receiver receiving the corresponding compressed divided image; and
an interface transmitter transmitting the corresponding compressed divided image to the video box controller of the second video box.

10. The video wall according to claim 8, wherein the video box controller of the first video box of the corresponding display daisy chain further comprises:
an image processing circuit receiving the first image and enabling the light emitting diode display module of the first video box to display the first image.

11. A video box controller, configured to control a first video box, wherein the video box controller comprises:
an image divided dividing a partial compressed image from a corresponding compressed divided image; and
a decompressor coupled to the image divider to receive the partial compressed image, wherein the decompressor decompresses the partial compressed image to generate a first image, so that the first video box displays a portion of a corresponding divided image.

12. The video box controller according to claim 11, further comprising:
an interface receiver receiving the corresponding compressed divided image from a source image compressor, wherein the image divider is coupled to the interface receiver to receive the corresponding compressed divided image; and
an interface transmitter coupled to the interface receiver to receive the corresponding compressed divided image, wherein the interface transmitter transmits the corresponding compressed divided image to another video box controller of a second video box.

13. The video box controller according to claim 11, wherein the first video box further comprises a light emitting diode display module, and the video box controller further comprises:
an image processing circuit coupled to the decompressor to receive the first image, such that the light emitting diode display module of the first video box displays the first image.

14. A video wall, comprising:
a source image compressor compressing a source image by using a tile-based compression algorithm to generate a compressed image; and
a display daisy chain coupled to the source image compressor through a cable to receive the compressed image, wherein the display daisy chain comprises a plurality of video boxes connected in series, each of the video boxes comprises a light emitting diode display module and a video box controller, the video box controller of any one of the video boxes of the display daisy chain divides a partial compressed image from the compressed image, and the video box controller of the any one of the video boxes of the display daisy chain decompresses the partial compressed image to display a portion of a corresponding divided image through the light emitting diode display module.

15. The video wall according to claim 14, wherein the source image compressor outputs the compressed image to the video box controller of a first video box of the video boxes of the display daisy chain through the cable, the video box controller of the first video box divides the partial compressed image corresponding to the first video box from the compressed image, the video box controller of the first video box decompresses the partial compressed image to generate a first image, the video box controller of the first video box controls the light emitting diode display module of the first video box to display the first image, and the video box controller of the first video box transmits the compressed image to the video box controller of a second video box of the video boxes of the display daisy chain.

16. The video wall according to claim 15, wherein the video box controller of the first video box comprises:
an image divider dividing the partial compressed image corresponding to the first video box from the compressed image; and
a decompressor coupled to the image divider to receive the partial compressed image, wherein the decompressor decompresses the partial compressed image to generate the first image, so that the first video box displays a portion of the corresponding divided image.

17. The video wall according to claim 16, wherein the video box controller of the first video box further comprises:
an interface receiver configured to receive the compressed image from the source image compressor, wherein the image divider is coupled to the interface receiver to receive the compressed image; and
an interface transmitter coupled to the interface receiver to receive the compressed image, wherein the interface transmitter transmits the compressed image to the video box controller of the second video box.

18. The video wall according to claim 16, wherein the video box controller of the first video box further comprises:
an image processing circuit coupled to the decompressor to receive the first image, wherein the image processing circuit performs image processing on the first image, so that the light emitting diode display module of the first video box displays the first image.
